(19) United States
(12) Patent Application Publication
(10) Pub. No.: US 2012/0180255 A1
(43) Pub. Date: Jul. 19, 2012

(54) DRUM TYPE VACUUM CLEANER AND ASSEMBLY METHOD OF THE SAME

(75) Inventors: Joung Soo PARK, Jeonju-si (KR); Sung Tae Joo, Gwangju (KR); Min Ha Kim, Gwangju (KR); Hyun Ju Lee, Gwangju (KR); Dong Hoon Yang, Gwangju (KR)

(73) Assignee: Samsung Electronics Co., Ltd., Suwon-si (KR)

(21) Appl. No.: 13/351,794

(22) Filed: Jan. 17, 2012

(30) Foreign Application Priority Data
Jan. 18, 2011 (KR) 10-2011-0005156

(51) Int. Cl. A47L 9/16; B23P 11/00

(52) U.S. Cl. 15/353; 29/592.1

(57) ABSTRACT

A drum type vacuum cleaner includes a centrifugal separator to separate dust from air using centrifugal force, a dust tank having an open top through which the centrifugal separator is mounted in the dust tank, the dust tank being provided with a dust collector to store the separated dust, and a cover unit having a motor to generate suction force, the cover unit being mounted to cover the top of the dust tank, wherein the centrifugal separator is disposed so that a central axis of rotary force of the centrifugal separator to whirl air is at a right angle to a central axis of the motor, whereby dust contained in suctioned air is discharged to the dust collector, and air from which dust has been separated is discharged to the outside by the motor provided at the cover unit.

### CROSS-REFERENCE TO RELATED APPLICATIONS

This application claims the benefit of Korean Patent Application No. 10-2011-0005156, filed on Jan. 18, 2011 in the Korean Intellectual Property Office, the disclosure of which is incorporated herein by reference.

### BACKGROUND

1. Field

Embodiments of the present disclosure relate to a drum type vacuum cleaner having a motor to generate suction force located at the upper part thereof, the drum type vacuum cleaner having a large dust capacity, and an assembly method of the same.

2. Description of the Related Art

Generally, a drum type vacuum cleaner, having a cloth bag type filter provided in a dust tank, suctions air containing dust, stores the dust, and discharges the air from which the dust has been removed.

In the vacuum cleaner, the filter is mounted in the dust tank at an air discharge portion thereof with the result that dust is attached to the filter, and therefore, the filter is frequently clogged. Consequently, suction force of the vacuum cleaner is reduced, and usability and repairability of the vacuum cleaner are lowered although the vacuum cleanser has a large dust tank.

### SUMMARY

It is an aspect of the present disclosure to provide a drum type vacuum cleaner to separate dust from air in a dust tank using a cyclone method and an assembly method of the same.

Additional aspects of the disclosure will be set forth in part in the description which follows and, in part, will be apparent from the description, or may be learned by practice of the disclosure.

In accordance with an aspect of the present disclosure, a drum type vacuum cleaner includes a centrifugal separator to separate dust from air using centrifugal force, a dust tank having an open top through which the centrifugal separator is mounted in the dust tank, the dust tank being provided with a dust collector to store the separated dust, and a cover unit having a motor to generate suction force, the cover unit being mounted to cover the top of the dust tank, wherein the centrifugal separator is disposed so that a central axis of rotary force of the centrifugal separator to whirl air is at a right angle to a central axis of the motor, whereby dust contained in suctioned air is discharged to the dust collector, and air from which dust has been separated is discharged to the outside by the motor provided at the cover unit.

The centrifugal separator may be provided at the upper side thereof with a predetermined space in which a portion of the motor is disposed so that the motor overlaps with the centrifugal separator.

The drum type vacuum cleaner may further include a filter assembly mounted in the centrifugal separator to filter air from which dust has been separated, wherein the filter assembly and the centrifugal separator may be simultaneously detached from and mounted in the dust tank.

The centrifugal separator may include an introduction pipe defining an introduction port and a centrifugal separation pipe having a dust discharge port communicating with the introduction port and the dust collector the dust tank may include a suction port assembly coupled to the introduction pipe of the centrifugal separator, and the suction port assembly may include a connection pipe having a suction hole through which dust is suctioned together with air by the suction force generated by the motor, the connection pipe being connected to a hose, and a suction pipe mounted at the connection pipe so that the suction pipe protrudes inward into the dust tank.

The introduction pipe may protrude outward from the centrifugal separation pipe and may have an inclined section in which the distance between the introduction pipe and the centrifugal separation pipe gradually decreases from the upper part to the lower part thereof, and the suction pipe may be inclined so that the distance between the suction pipe and the dust tank gradually increases from the upper part to the lower part thereof and thus the inclination of the suction pipe is in tight contact with the section of the introduction pipe.

The centrifugal separation pipe may further include a grill through which air from which dust has been separated is discharged and an exhaust pipe to discharge the air having passed through the grill, the centrifugal separation pipe may be provided at the side opposite to the grill with an opening, and a stabilizer may be attached to the inside of the dust tank opposite to the opening, the stabilizer being coupled to the centrifugal separation pipe.

The centrifugal separator may be formed so that the diameter of the upper side of the centrifugal separator gradually decreases from the upper part to the lower part of the upper side thereof.

The drum type vacuum cleaner may further include a packing member fitted on the upper edge of the centrifugal separator, wherein the lower end of the cover unit may be coupled to the upper part of the packing member in a tight contact fashion, and the upper end of the dust tank may be coupled to the lower part of the packing member in a tight contact fashion.

The drum type vacuum cleaner may further include a grip provided at the top of the cover unit to enable movement of the vacuum cleaner.

The cover unit may have an air discharge port.

In accordance with another aspect of the present disclosure, an assembly method of a drum type vacuum cleaner includes preparing a dust tank opened at the top thereof, the dust tank having a dust collector to store dust, inserting a centrifugal separator to separate dust from air using centrifugal force into the dust tank through the open top of the dust tank so that the centrifugal separator is mounted at the upper part of the dust tank, and installing a cover unit having a motor to generate suction force in the dust tank so that a central axis of rotary force of the centrifugal separator to whirl air is at a right angle to a central axis of the motor.

The assembly method may further include fitting a packing member on the edge of the centrifugal separator so that the lower end of the packing member is coupled to the upper end of the dust tank in a tight contact fashion and the upper end of the packing member is coupled to the lower end of the cover unit in a tight contact fashion.

Installing a cover unit having a motor to generate suction force in the dust tank so that a central axis of rotary force of the centrifugal separator to whirl air is at a right angle to a central axis of the motor may include placing a portion of the motor in the upper side of the centrifugal separator so that the motor overlaps with the centrifugal separator to cover the top of the dust tank.

The centrifugal separator may be formed so that the diameter of the upper side of the centrifugal separator gradually decreases from the upper part to the lower part of the upper side thereof and thus the centrifugal separator is easily detached from the dust tank.

The assembly method may further include disposing a suction pipe having a suction hole in the dust tank so that the suction pipe protrudes inward into the dust tank, the suction pipe having an inclined section in which the distance between the suction pipe and the dust tank gradually increases from the upper part to the lower part thereof, wherein the centrifugal separator may be provided with an introduction pipe having an introduction port coupled to the suction pipe, the introduction pipe having an inclined section in tight contact with the section of the suction pipe, whereby the suction pipe and the introduction pipe are coupled to each other when the centrifugal separator is mounted in the dust tank.

The assembly method may further include installing a filter to filter air from which dust has been separated, wherein the filter assembly and the centrifugal separator may be simultaneously detached from and mounted in the dust tank.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exploded perspective view illustrating a drum type vacuum cleaner according to an embodiment of the present disclosure;

FIG. 2 is an assembled perspective view of FIG. 1;

FIG. 3 is a partial sectional view illustrating the internal structure of the drum type vacuum cleaner according to the embodiment of the present disclosure;

FIG. 4 is a partial sectional view illustrating a state in which a dust tank and a cover unit are simultaneously sealed by a packing member mounted in a centrifugal separator of the embodiment of the present disclosure;

FIG. 5 is a partial sectional view illustrating a state in which an introduction pipe and a suction pipe of the embodiment of the present disclosure are coupled to each other; and

FIG. 6 is a view illustrating a state in which air flows in the drum type vacuum cleaner according to the embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

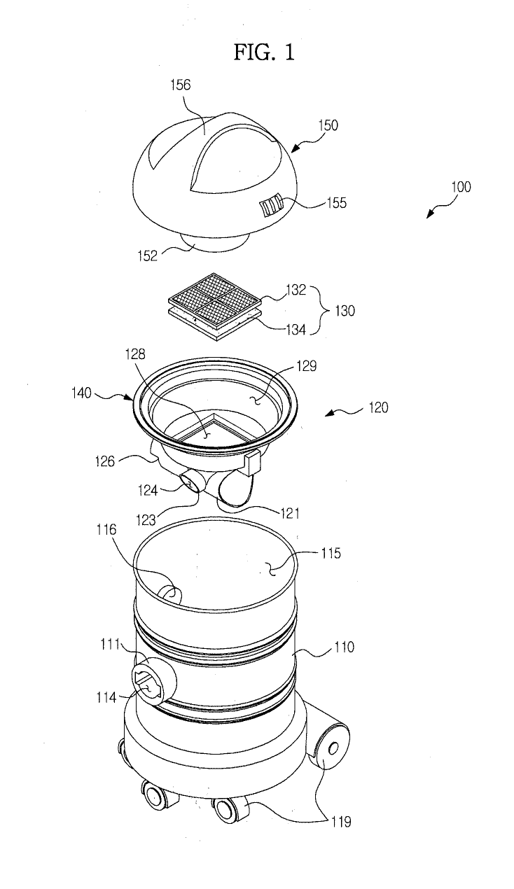

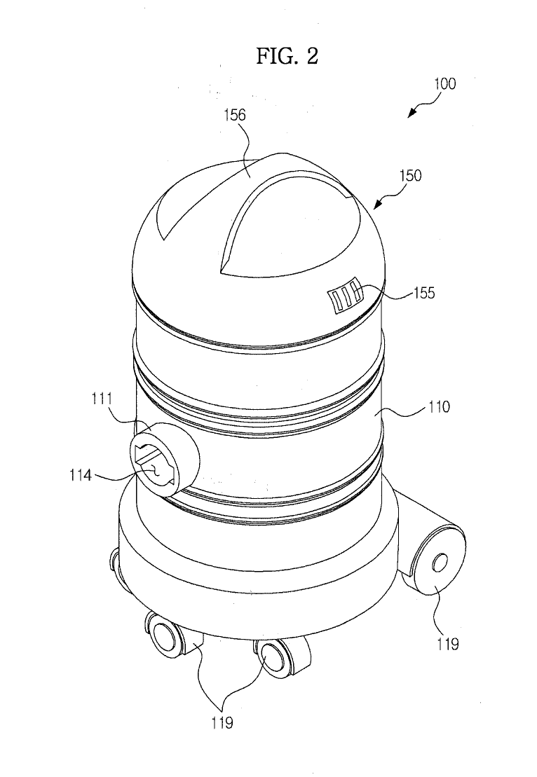

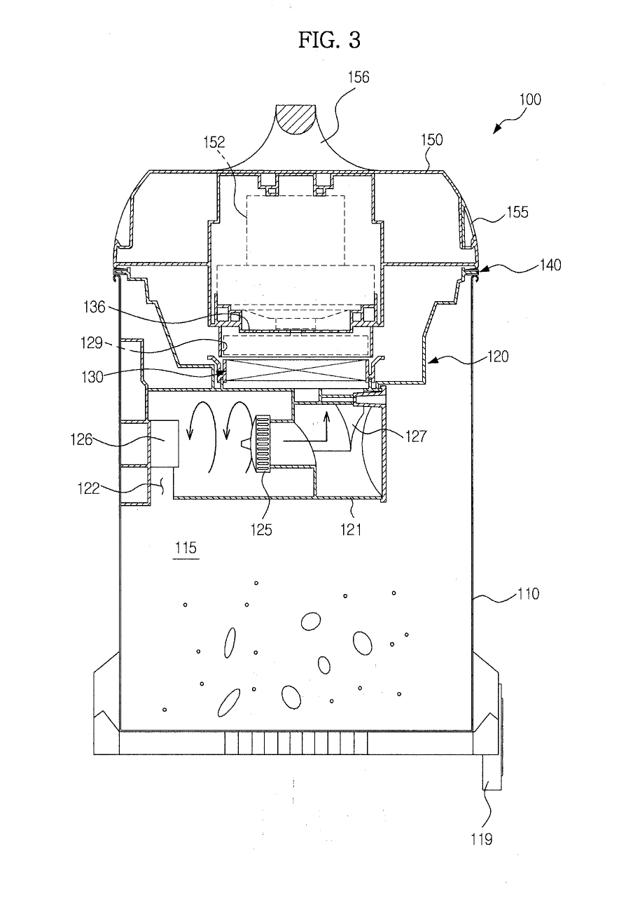

FIG. 1 is an exploded perspective view illustrating a drum type vacuum cleaner 100 according to an embodiment of the present disclosure, FIG. 2 is an assembled perspective view of FIG. 1, and FIG. 3 is a partial sectional view illustrating the internal structure of the drum type vacuum cleaner according to the embodiment of the present disclosure.

As shown in FIGS. 1 to 3, the drum type vacuum cleaner 100 includes a dust tank 110 open at the top thereof, a centrifugal separator 120 mounted in the dust tank 110 so that the centrifugal separator 120 is detached from the dust tank 110 through the open top of the dust tank 110, and a cover unit 150 mounted above the centrifugal separator 120 to cover the top of the dust tank 110.

The dust tank 110 is formed in the shape of a drum open at the top thereof. The dust tank 110 includes a suction port assembly having a suction hole 114 formed at one side thereof and a stabilizer 116 mounted therein.

The suction port assembly includes a connection pipe 111 protruding outward from the dust tank 110 so as to be connected to a flexible hose (not shown) and a suction pipe 113 mounted at the connection pipe 111 so that the suction pipe 113 protrudes inward into the dust tank 110. A suction hole 114 extends through the connection pipe 111 and the suction pipe 113 so that the interior of the dust tank 110 communicates with the outside through the suction hole 114.

The suction pipe 113 has an inclined section in which the lower part of the suction pipe 113 protrudes farther from the dust tank 110 than the upper part of the suction pipe 113. That is, the suction pipe 113 is inclined so that the distance between the suction pipe 113 and the dust tank 110 increases from the upper part to the lower part of the suction pipe 113. The suction pipe 113 is easily coupled to an introduction pipe 123 of the centrifugal separator 120, which will be described below, by virtue of the inclination of the suction pipe 113.

In the dust tank 110 is provided a dust collector 115 to store dust separated by the centrifugal separator 120. Although not shown, the dust collector 115 may be detached from the dust tank 110 so that dust stored in the dust collector 115 is disposed of.

Meanwhile, unexplained reference numeral 119 indicates wheels to enable the vacuum cleaner 110 to easily move.

The centrifugal separator 120 is formed in the shape of a horizontally disposed pipe. The centrifugal separator 120 separates dust using centrifugal force. The centrifugal separator 120 is disposed so that a central axis of rotary force of the centrifugal separator 120 to whirl air is at a right angle to a central axis of a motor 152.

The centrifugal separator 120 includes an introduction pipe 123 coupled to the suction pipe 113 formed at the dust tank 110 to allow external air to be introduced into the centrifugal separator 120 therethrough and a centrifugal separation pipe 121 having a dust discharge port 122 through which dust separated from the introduced air by whirling the air is discharged.

The introduction pipe 123 has an introduction hole 124 communicating with the suction hole 114 of the suction pipe 113. The introduction pipe 123 has an inclined section in which the length of the lower part of the inlet of the introduction pipe 123 from the centrifugal separator 120 is shorter than that of the upper part of the inlet of the introduction pipe 123 from the centrifugal separator 120. The introduction pipe 123 is located at a position corresponding to the suction pipe 113 when the centrifugal separator 120 is mounted in the dust tank 110.

The centrifugal separation pipe 121 whirls dust contained in the air suctioned through the suction pipe 113 to separate dust from the air and discharges the separated dust to the dust collector 115 of the dust tank 110 through the dust discharge port 122. In the centrifugal separation pipe 121 is formed a grill 125 through which air, from which dust has been separated, passes. The centrifugal separation pipe 121 further includes an exhaust port 127 through which the air having passed through the grill 125 is discharged. An opening 126 is formed at the side of the centrifugal separation pipe 121 opposite to the grill 125. When the centrifugal separator 120 is mounted in the dust tank 110, the stabilizer 116 is located in the dust tank 110 so as to be opposite to the opening 126.

Meanwhile, the exhaust pipe 127 has a section enlarged upward. A filter assembly 130 is detachably mounted at the upper end of the exhaust pipe 127. That is, as shown in FIG. 1, a location groove 128, in which the filter assembly 130 is located, is provided at the upper end of the exhaust pipe 127 to stably mount the filter assembly 130.

The filter assembly 130 may include a filter case 132 and a micro filter 134. The filter assembly 130 is provided to filter microscopic dust which may be contained in air, from which large dust has been separated by the centrifugal separator 120. Additional well-known filters in addition to the micro filter 134 may be selectively mounted in the filter case 132.

The filter assembly 130 is mounted in the centrifugal separator 120. Consequently, the centrifugal separator 120 and the filter assembly 130 may be simultaneously detached from or mounted in the dust tank 110. At the upper end of the centrifugal separator 120 may be provided a grip (not shown) may be provided by which the centrifugal separator 120 may be easily mounted or detached.

In addition, the centrifugal separator 120 is formed so that the diameter of the upper side of the centrifugal separator 120 gradually decreases from the upper part to the lower part of the upper side of the centrifugal separator 120. This structure improves assembly convenience when the centrifugal separator 120 is mounted in or detached from the dust tank 110.

At the cover unit 150 is provided a motor 152 to generate suction force.

The motor 152 is mounted below the center of the cover unit 150 so that a portion of the lower side of the motor 152 overlaps with the centrifugal separator 120 when the cover unit 150 covers the top of the dust tank 110. At the upper side of the centrifugal separator 120 is defined a space 129 in which the motor 152 is mounted. When the cover unit 150 is mounted, therefore, a portion of the lower side of the motor 152 is located at the upper side of the centrifugal separator 120 with the result that the total height of the vacuum cleaner is reduced, thereby achieving a compact assembly structure.

The motor 152 generates suction force, air introduced by the suction force passes through the centrifugal separator 120, and air, from which dust has been separated by the centrifugal separator 120, is discharged to the outside through an air discharge port 155 formed at the cover unit 150.

A grip 156 is provided at the top of the cover unit 150. The grip 156 enables the cover unit 150 to be easily mounted and detached and the vacuum cleaner 100 to be easily moved. The grip 156 may be integrally formed at the cover unit 150.

Meanwhile, unexplained reference numeral 136 indicates an exhaust hole through which air having passed through the filter assembly 130 is discharged to the air discharge port 155 of the cover unit 150.

In this embodiment, a packing member 140 is further provided to simultaneously achieve sealing between the centrifugal separator 120 and the cover unit 150 and between the centrifugal separator 120 and the dust tank 110 when the cover unit 150, the centrifugal separator 120 and the dust tank 110 are assembled.

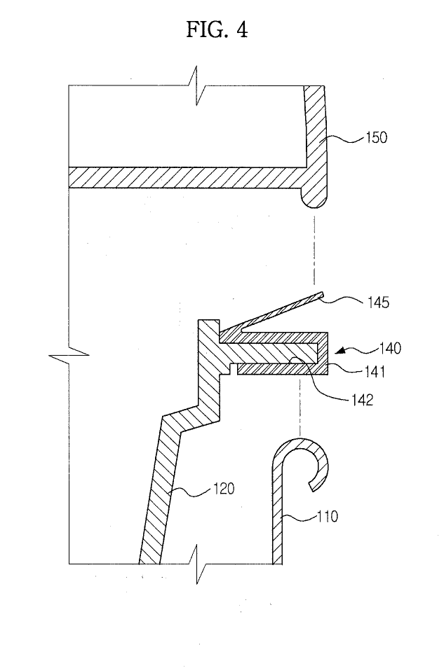

Referring to FIG. 4, the packing member 140 is fitted on the edge of the centrifugal separator 120 so as to surround the edge of the centrifugal separator 120. More specifically, the packing member 140 includes a sealing part 141 having a groove 142, into which the edge of the centrifugal separator 120 is inserted, and an extension part 145 extending to the diagonal upper side of the sealing part 141. The lower part of the packing member 140, i.e. the lower end of the sealing part 141, is in tight contact with the upper end of the dust tank 110, and the upper end of the packing member 140, i.e. the extension part 145, is in tight contact with the lower end of the cover unit 150. Consequently, the packing member 140 simultaneously achieves sealing between the centrifugal separator 120 and the cover unit 150 and between the centrifugal separator 120 and the dust tank 110, thereby improving sealability and assemblability of the vacuum cleaner 100.

Hereinafter, an assembly method of the vacuum cleaner with the above-stated construction will be described with reference to FIGS. 1 to 5.

First, a dust tank 110, formed in the shape of a drum, having a suction port assembly and a stabilizer 116 mounted therein is prepared. The top of the dust tank 110 is open. A dust collector 115 is provided in the dust tank 110, and wheels 119 to enable the dust tank 110 to easily move are mounted at the bottom of the dust tank 110.

Subsequently, a centrifugal separator 120 is inserted into the dust tank 110 through the open top of the dust tank 110, and the upper edge of the centrifugal separator 120 is mounted at the open top of the dust tank 110. At this time, the centrifugal separator 120 may be forcibly fitted to the circumference of the open upper inlet of the dust tank 110.

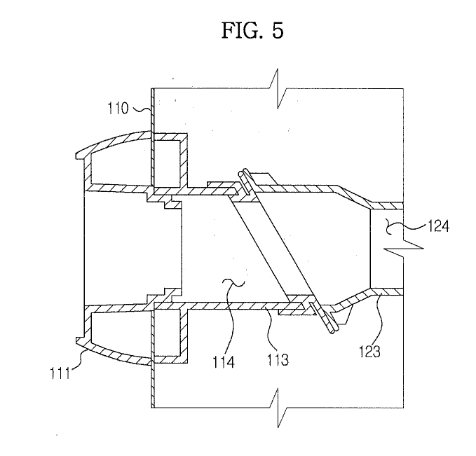

When the centrifugal separator 120 is mounted in the dust tank 110, as shown in FIG. 3, an opening 126 of a centrifugal separation pipe 121 is coupled to the stabilizer 116 of the dust tank 110, and, as shown in FIG. 5, an introduction pipe 123 slides along the inclined section of a suction pipe 113 to be coupled to the suction pipe 113. Consequently, the insertion of the centrifugal separator 120 into the dust tank 110 is not disturbed by the suction pipe 113, thereby securely achieving sealed coupling between the introduction pipe 123 and the suction pipe 113. When a user wishes to detach the centrifugal separator 120 from the dust tank 110, the user may pull the centrifugal separator 120 upward while holding an upper grip (not shown) of the centrifugal separator 120 with the result that the centrifugal separator 120 is drawn out of the dust tank 110 through the open top of the dust tank 110.

The centrifugal separator 120 is formed so that the diameter of the upper side of the centrifugal separator 120 gradually decreases from the upper part to the lower part of the upper side of the centrifugal separator 120. This structure enables easy insertion and detachment when the centrifugal separator 120 is inserted into or detached from the dust tank 110.

Meanwhile, a filter assembly 130 is mounted in the centrifugal separator 120. The filter assembly 130 may be disposed after or before the centrifugal separator 120 is mounted in the dust tank 110. When the centrifugal separator 120 is detached from or mounted in the dust tank 110, therefore, the centrifugal separator 120 and the filter assembly 130 may be simultaneously detached from or mounted in the dust tank 110.

When the centrifugal separator 120 is mounted in the dust tank 110, a cover unit 150 is mounted to the dust tank 110 from above so as to cover the top of the dust tank 110. At this time, a portion of a motor 152 provided at the cover unit 150 is inserted into a predetermined space 129 defined at the upper part of the centrifugal separator 120 so that the motor 152 overlaps with the centrifugal separator 120. Consequently, the total height of the vacuum cleaner is reduced, thereby achieving a compact assembly structure.

Meanwhile, the centrifugal separator 120 is formed in the shape of a horizontally disposed pipe. When the centrifugal separator 120 and the cover unit 150 are assembled, therefore, the centrifugal separator 120 is disposed so that a central axis of rotary force of the centrifugal separator 120 to whirl air is at a right angle to a central axis of the motor 152.

In addition, a packing member 140 may be further mounted at the centrifugal separator 120 to achieve sealing between the centrifugal separator 120 and the cover unit 150 and between the centrifugal separator 120 and the dust tank 110. That is, before the centrifugal separator 120 is mounted in the dust tank 110, the packing member 140 is fitted on the edge of the centrifugal separator 120. As a result, the upper part of the packing member 140 is in tight contact with the lower end of the cover unit 150, and the lower part of the packing member is in tight contact with the upper end of the dust tank 110. When the vacuum cleaner 100 is assembled, therefore, sealing between the centrifugal separator 120 and the cover unit 150 and between the centrifugal separator 120 and the dust tank 110 is simultaneously achieved by the packing member 140.

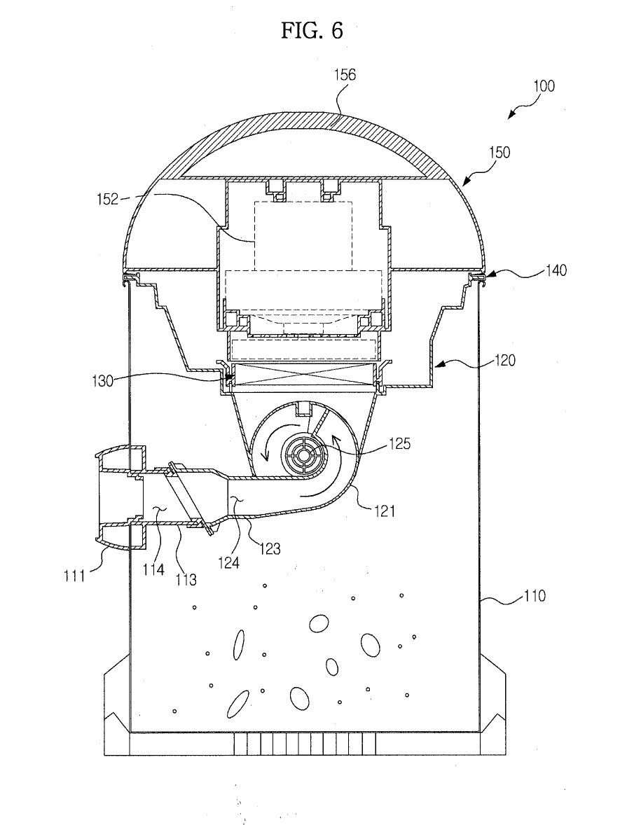

Hereinafter, a process of suctioning air containing dust, collecting dust, and discharging air, performed by the drum type vacuum cleaner 100 assembled as described above, will be described with reference to FIGS. 3 and 6.

First, when power is supplied to the motor 152, the motor 152 generates suction force, and air containing dust is suctioned by the suction force. At this time, the dust is suctioned through a flexible hose (not shown) connected to the connection pipe 111 provided at the dust tank 110.

The dust contained in the suctioned air moves into the centrifugal separation pipe 121 through the suction hole 114 and the introduction hole 124 of the suction pipe 113 and the introduction pipe 123, which are coupled to each other. The dust is whirled in the centrifugal separation pipe 121. As a result, heavy dust is whirled by centrifugal force and is discharged into the dust collector 115 of the dust tank 110 through the dust discharge port 122.

The air, from which the dust has been separated, moves to the filter assembly 130 provided at the upper side of the exhaust pipe 127 through the grill 125. At this time, microscopic dust contained in the air is filtered by the filter assembly 130. Subsequently, the air is transferred to the cover unit 150 through the exhaust hole 136 and is discharged to the outside through the air discharge port 155 formed at the cover unit 150. The air transferred to the cover unit 150 may be smoothly discharged to the air discharge port 155 by the motor 152.

As is apparent from the above description, the cyclone type centrifugal separator to separate dust from air using centrifugal force is applied to the drum type vacuum cleaner according to the embodiment of the present disclosure, thereby preventing the filter from being clogged. Also, the motor mounted at the cover unit is mounted in the centrifugal separator in an overlapping fashion, and therefore, the height of the vacuum cleaner is reduced, thereby achieving a compact structure.

In addition, the filter assembly is mounted in the centrifugal separator, and the centrifugal separator and the filter assembly are simultaneously detached from or mounted in the dust tank, thereby achieving easy assembly. Also, the upper side of the centrifugal separator and the introduction pipe coupled to the suction pipe are inclined, thereby achieving easier assembly of the centrifugal separator.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A drum type vacuum cleaner comprising:
a centrifugal separator to separate dust from air using centrifugal force;
a dust tank having an open top through which the centrifugal separator is mounted in the dust tank, the dust tank being provided with a dust collector to store the separated dust; and
a cover unit having a motor to generate suction force, the cover unit being mounted to cover the top of the dust tank, wherein
the centrifugal separator is disposed so that a central axis of rotary force of the centrifugal separator to whirl air is at a right angle to a central axis of the motor, whereby dust contained in suctioned air is discharged to the dust collector, and air from which dust has been separated is discharged to an outside by the motor provided at the cover unit.

2. The drum type vacuum cleaner according to claim 1, wherein the centrifugal separator is provided at an upper side thereof with a predetermined space in which a portion of the motor is disposed so that the motor overlaps with the centrifugal separator.

3. The drum type vacuum cleaner according to claim 1, further comprising a filter assembly mounted in the centrifugal separator to filter air from which dust has been separated, wherein the filter assembly and the centrifugal separator are simultaneously detached from and mounted in the dust tank.

4. The drum type vacuum cleaner according to claim 1, wherein
the centrifugal separator comprises an introduction pipe defining an introduction port and a centrifugal separation pipe having a dust discharge port communicating with the introduction port and the dust collector,
the dust tank comprises a suction port assembly coupled to the introduction pipe of the centrifugal separator, and
the suction port assembly comprises a connection pipe having a suction hole through which dust is suctioned together with air by the suction force generated by the motor, the connection pipe being connected to a hose, and a suction pipe mounted at the connection pipe so that the suction pipe protrudes inward into the dust tank.

5. The drum type vacuum cleaner according to claim 4, wherein
the introduction pipe protrudes outward from the centrifugal separation pipe and has an inclined section in which a distance between the introduction pipe and the centrifugal separation pipe gradually decreases from an upper part to a lower part thereof, and
the suction pipe is inclined so that a distance between the suction pipe and the dust tank gradually increases from an upper part to a lower part thereof and thus the inclination of the suction pipe is in tight contact with the section of the introduction pipe.

6. The drum type vacuum cleaner according to claim 4, wherein the centrifugal separation pipe further comprises a grill through which air from which dust has been separated is discharged and an exhaust pipe to discharge the air having passed through the grill, the centrifugal separation pipe is provided at a side opposite to the grill with an opening, and a stabilizer is attached to an inside of the dust tank opposite to the opening, the stabilizer being coupled to the centrifugal separation pipe.

7. The drum type vacuum cleaner according to claim 1, wherein the centrifugal separator is formed so that a diameter of an upper side of the centrifugal separator gradually decreases from an upper part to a lower part of the upper side thereof.

8. The drum type vacuum cleaner according to claim 1, further comprising a packing member fitted on an upper edge of the centrifugal separator, wherein
a lower end of the cover unit is coupled to an upper part of the packing member in a tight contact fashion, and an upper end of the dust tank is coupled to a lower part of the packing member in a tight contact fashion.

9. The drum type vacuum cleaner according to claim 1, further comprising a grip provided at a top of the cover unit to enable movement of the vacuum cleaner.

10. The drum type vacuum cleaner according to claim 1, wherein the cover unit has an air discharge port.

11. An assembly method of a drum type vacuum cleaner comprising:
preparing a dust tank opened at a top thereof, the dust tank having a dust collector to store dust;
inserting a centrifugal separator to separate dust from air using centrifugal force into the dust tank through the open top of the dust tank so that the centrifugal separator is mounted at an upper part of the dust tank; and
installing a cover unit having a motor to generate suction force in the dust tank so that a central axis of rotary force of the centrifugal separator to whirl air is at a right angle to a central axis of the motor.

12. The assembly method according to claim 11, further comprising fitting a packing member on an edge of the centrifugal separator so that a lower end of the packing member is coupled to an upper end of the dust tank in a tight contact fashion and an upper end of the packing member is coupled to a lower end of the cover unit in a tight contact fashion.

13. The assembly method according to claim 11, wherein installing a cover unit having a motor to generate suction force in the dust tank so that a central axis of rotary force of the centrifugal separator to whirl air is at a right angle to a central axis of the motor comprises placing a portion of the motor in an upper side of the centrifugal separator so that the motor overlaps with the centrifugal separator to cover the top of the dust tank.

14. The assembly method according to claim 11, wherein the centrifugal separator is formed so that a diameter of an upper side of the centrifugal separator gradually decreases from an upper part to a lower part of the upper side thereof and thus the centrifugal separator is easily detached from the dust tank.

15. The assembly method according to claim 11, further comprising disposing a suction pipe having a suction hole in the dust tank so that the suction pipe protrudes inward into the dust tank, the suction pipe having an inclined section in which a distance between the suction pipe and the dust tank gradually increases from an upper part to a lower part thereof, wherein
the centrifugal separator is provided with an introduction pipe having an introduction port coupled to the suction pipe, the introduction pipe having an inclined section in tight contact with the section of the suction pipe, whereby the suction pipe and the introduction pipe are coupled to each other when the centrifugal separator is mounted in the dust tank.

16. The assembly method according to claim 11, further comprising installing a filter to filter air from which dust has been separated, wherein the filter assembly and the centrifugal separator are simultaneously detached from and mounted in the dust tank.
